(19) United States
(12) Patent Application Publication
(10) Pub. No.: US 2026/0340359 A1
(43) Pub. Date: Oct. 29, 2026

(54) MANAGING GENERATIVE ARTIFICIAL INTELLIGENCE (AI) MODEL OUTPUTS USING RE-ORDERED MOTIFS

(71) Applicant: Dell Products L.P., Round Rock, TX (US)

(72) Inventors: OFIR EZRIELEV, Be'er Sheva (IL); HANNA YEHUDA, Acton, MA (US); ANNE-MARIE MCREYNOLDS, San Jose, CA (US)

(21) Appl. No.: 19/191,463

(22) Filed: Apr. 28, 2025

(51) Int. Cl. G06N 3/0475; G06F 16/3329; G06N 3/10

(52) U.S. Cl. CPC G06N 3/0475; G06F 16/33295; G06N 3/105

(57) ABSTRACT

Methods and systems for providing computer-implemented services using generative AI models are disclosed. To do so, a prompt may be obtained for a first generative AI model of the generative AI models. The prompt may be iteratively perturbated to obtain perturbated prompts. The perturbated prompts and the first generative AI model may be used to obtain perturbated outputs. Motifs for the perturbated outputs may be obtained, the motifs including portions of the perturbated outputs that occur repeatedly among the perturbated outputs. An output alignment optimization process may be performed, using an output alignment optimization schema, to obtain aligned outputs, the aligned outputs including one or more re-ordered motifs of the motifs to increase alignment between different perturbated outputs of the perturbated outputs. Computer-implemented services may be provided to a downstream consumer using at least the aligned outputs.

### FIELD

Embodiments disclosed herein relate generally to providing computer-implemented services using generative artificial intelligence (AI) models. More particularly, embodiments disclosed herein relate to managing generative AI model outputs using re-ordered motifs.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a diagram illustrating a system in accordance with an embodiment.

FIGS. 2A-2B show flow diagrams illustrating data flows in accordance with an embodiment.

FIGS. 2C-2L show examples of a graphical user interface (GUI) and an output alignment optimization process in accordance with an embodiment.

FIG. 3 shows a flow diagram illustrating a method for providing computer-implemented services using generative AI models in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for providing computer-implemented services using generative AI models. The generative AI models may include large language models (LLMs) that may generate outputs when provided with prompts. The outputs may be used, at least in part, to provide the computer-implemented services. For example, the outputs may be provided to a downstream consumer and the downstream consumer may use the outputs to make decisions.

However, a usefulness of the outputs to the downstream consumer may be reduced if the downstream consumer does not know why a particular output was generated. For example, a downstream consumer (e.g., a client, a customer) may desire to use an output to manage a computer system. In addition, the computer system managed by the client may store private medical information, private financial information, and/or other data protected by various regulatory standards (e.g., General Data Protection Regulation (GDPR), Health Insurance Portability and Accountability Act (HIPAA)).

If the downstream consumer does not understand why a particular output was generated, the downstream consumer may be unwilling to use the output and/or make decisions based on the output. For example, portions of data used as ingest for the generative AI model may have different degrees of influence on the output and, therefore, modifications to the ingest data may yield different outcomes. If these outcomes have a high degree of variability (e.g., if the stability of a portion of the output is low relative to other portions of the output), downstream consumers may not trust the outputs.

To provide information to the downstream consumer regarding stability of portions of an output, variability information for portions of outputs may be provided to downstream consumers along with the outputs. The variability information may provide insight into a generative AI model's decision-making processes and may allow the downstream consumer to make adjustments to the prompt and/or the available data sources to alter a particular portion of the output.

To obtain the variability information, a prompt for a generative AI model may be iteratively perturbated (e.g., information elements of the prompt may be removed or replaced with replacement information elements) to obtain perturbated prompts. The perturbated prompts and the generative AI model may be used to generate perturbated outputs (e.g., outputs generated by the generative AI model using at least the perturbated prompts as ingest).

Motifs may be obtained for the perturbated outputs, the motifs including portions of the perturbated outputs that occur repeatedly among the perturbated outputs. For example, a first perturbated output of the perturbated outputs may include a first sequence of tokens. Motifs may include one or more tokens of the sequence of the tokens that appear in at least one other perturbated output of the perturbated outputs. For example, a motif may include: (i) a topic, (ii) a paragraph, (iii) a sub-chapter, (iv) a phrase, and/or (v) other collections of tokens such as for other data modalities (e.g., groupings of pixels of an image).

An output alignment optimization process may be performed, using an output alignment optimization schema, to obtain aligned outputs. The aligned outputs may include one or more re-ordered motifs of the motifs to increase alignment between different perturbated outputs of the perturbated outputs. The output alignment optimization schema may include an objective function that proportionally penalizes re-ordering based on an extent of the re-ordering.

Performing the output alignment optimization process may include: (i) re-ordering motifs of the perturbated outputs to obtain re-ordered outputs, and (ii) shifting placement of portions of the re-ordered outputs to generate the aligned outputs. The motifs may be re-ordered based on a motif consensus (e.g., a most common ordering of the motifs in the perturbated outputs).

The aligned outputs may be compared to obtain variability information for the aligned outputs. The variability information may be based on differences between portions of the aligned outputs, frequencies of occurrences for motifs of the aligned outputs, and/or other information.

Computer-implemented services may be provided to downstream consumers using at least the aligned outputs. For example, the degrees of variability, the aligned outputs, and/or other information may be uploaded to a graphical user interface (GUI) that is available to the downstream consumers. In addition, at least one action may be selected based on the aligned outputs and the at least one action may be performed to modify operation of a system.

Thus, embodiments disclosed herein may provide an improved method for providing computer-implemented services using generative AI models. To provide the computer-implemented services as desired by downstream consumers, information related to variability of portions of outputs may be provided to the downstream consumers along with the outputs generated by the generative AI model. The variability information may indicate stability of the portions of outputs thereby increasing a usefulness of the outputs to the downstream consumer.

In an embodiment, a method for providing computer-implemented services using generative AI models is provided. The method may include: obtaining a prompt for a first generative AI model of the generative AI models; iteratively perturbating the prompt to obtain perturbated prompts; using the first generative AI model and the perturbated prompts to obtain perturbated outputs; obtaining motifs for the perturbated outputs, the motifs comprising portions of the perturbated outputs that occur repeatedly among the perturbated outputs; performing, using an output alignment optimization schema, an output alignment optimization process to obtain aligned outputs, the aligned outputs comprising one or more re-ordered motifs of the motifs to increase alignment between different perturbated outputs of the perturbated outputs; and providing computer-implemented services to a downstream consumer using at least the aligned outputs.

Performing the output alignment optimization process may include: identifying, using the output alignment optimization schema, a motif consensus, the motif consensus indicating a most common ordering for the motifs; re-ordering, based on the motif consensus and the output alignment optimization schema, motifs of one or more of the perturbated outputs to obtain re-ordered outputs; and shifting, using the output alignment optimization schema, portions of the re-ordered outputs to increase alignment between placement of the portions of the re-ordered outputs to generate the aligned outputs.

The output alignment optimization schema may be used to align the portions of the perturbated outputs. The output alignment optimization schema may include an objective function that proportionally penalizes re-ordering based on an extent of the reordering.

The portions of the perturbated outputs may include one or more tokens of sequences of tokens associated with each perturbated output of the perturbated outputs.

A token of the one or more tokens may include at least one type of token selected from a list of types of tokens consisting of: a word; a letter; a punctuation mark; and a phrase.

Obtaining the motifs may include: obtaining a first sequence of tokens corresponding to a first perturbated output of the perturbated outputs; and obtaining, using at least the first sequence of tokens, the perturbated outputs, and similarity criteria, first motifs for the first sequence of tokens and frequencies of occurrence for the first motifs in other perturbated outputs of the perturbated outputs.

The similarity criteria may indicate an acceptable deviation in information content for a first motif of the first motifs to be considered a same motif as a second motif of the first motifs.

Providing the computer-implemented services may include: comparing the aligned outputs to obtain variability information for the aligned outputs, the variability information comprising at least one type of information selected from a list of types of information consisting of: differences between portions of a first aligned output of the aligned output and other aligned outputs of the aligned outputs; and frequencies of occurrence for motifs of the first aligned output in the other aligned outputs.

Providing the computer-implemented services may also include: populating, using at least the variability information and the aligned outputs, a graphical user interface (GUI) to obtain a populated GUI, the populated GUI being accessible by the downstream consumer.

Providing the computer-implemented services may include: populating, using at least the aligned outputs, a graphical user interface (GUI) to obtain a populated GUI, the populated GUI being viewable by the downstream consumer.

The populated GUI may highlight at least re-ordered motifs of a selected aligned output of the aligned outputs to focus an attention of the downstream consumer on at least the re-ordered motifs.

Providing the computer-implemented services may also include: selecting an action based on motifs of a selected aligned output of the aligned outputs; and updating operation of a system using the selected action.

Iteratively perturbating the prompt may include: obtaining first information elements of the prompt; and performing at least one action selected from a list of actions consisting of: removing a first information element of the first information elements to obtain a first perturbated prompt of the perturbated prompts, and replacing the first information element with a replacement information element to obtain the first perturbated prompt.

The first generative AI model may be a large language model (LLM).

In an embodiment, a non-transitory media is provided. The non-transitory media may include instructions that when executed by a processor cause the computer-implemented method to be performed.

In an embodiment, a system is provided. The system may include the non-transitory media and a processor, and may perform the computer-implemented method when the computer instructions are executed by the processor.

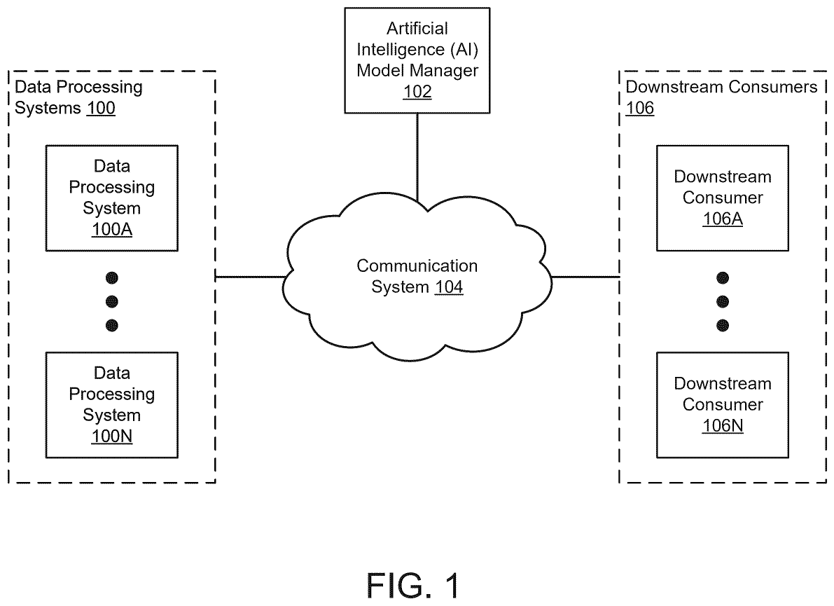

Turning to FIG. 1, a block diagram illustrating a system in accordance with an embodiment is shown. The system shown in FIG. 1 may provide for management of data processing systems that may provide, at least in part, computer-implemented services (e.g., to users of the system and/or devices operably connected to the system).

The computer-implemented services may include any type and quantity of computer-implemented services. The computer-implemented services may include, for example, database services, data processing services, electronic communication services, inference generation services, and/or any other services that may be provided using one or more computing devices. The computer-implemented services may be provided by, for example, data processing systems 100, AI model manager 102, downstream consumers 106, and/or any other type of devices (not shown in FIG. 1). Other types of computer-implemented services may be provided by the system shown in FIG. 1 without departing from embodiments disclosed herein.

The computer-implemented services may be provided, at least in part, using generative AI models and/or outputs obtained using the generative AI models. To do so, data processing systems 100 and/or AI model manager 102 may host any number of generative AI models.

To obtain the outputs, the generative AI models may be trained, using training data, to generate the outputs when provided with prompts (e.g., ingest data). The generative AI models may include large language models (LLMs) and, therefore, the outputs may include new instances of data created by the generative AI models based on learned associations from and/or an understanding of the training data. For example, the generative AI models may be trained using unstructured data, such as stories, essays, audio transcription, video description, and/or other types of human interpretable text, to generate outputs of the same. The outputs may be provided to downstream consumers 106 (e.g., client devices, data processing systems that manage computer systems and/or production systems) as part of providing the computer-implemented services.

However, the outputs may be provided to downstream consumers 106 as part of: (i) customer service requests (e.g., troubleshooting computer systems), (ii) data management processes (e.g., healthcare data, financial data), (iii) production system management processes (e.g., industrial applications), and/or (iv) other processes. The outputs, therefore, may be desired (e.g., by downstream consumers 106) to meet certain expectations. For example, downstream consumers 106 may expect the generative AI model and the outputs to comply with data privacy regulations (e.g., GDPR, HIPAA), may desire to mitigate unintended bias in outputs (e.g., when using the responses to make decisions based on financial data of consumers), and/or may otherwise wish to understand, audit, and/or modify operation of the generative AI models.

For example, information content of outputs generated by downstream consumers may have high degrees of variability when ingest data for the generative AI model is modified (e.g., different phrasing of a prompt, removal of portions of the prompt). If an output is considered unstable (e.g., portions of the output vary over a wide range with modifications to portions of the prompt), downstream consumers 106 may not trust the outputs. If downstream consumers 106 are unable to determine whether the generative AI models and/or the outputs meet their expectations, a usefulness of the outputs to downstream consumers 106 may be reduced.

In general, embodiments disclosed herein may provide methods, systems, and/or devices for providing variability information for portions of outputs generated by generative AI models along with the outputs. The variability information may indicate (e.g., in human-interpretable text) stability of portions of the output, which may increase a usefulness of the outputs to downstream consumers 106.

To do so, a prompt for a first generative AI model may be obtained. The prompt may be iteratively perturbated (e.g., information elements of the prompt may be removed, information elements of the prompt may be replaced with replacement information elements) to obtain perturbated prompts. The perturbated prompts and a first generative AI model may be used to generate perturbated outputs. For example, the perturbated prompts may be fed into the first generative AI model and the perturbated outputs may be obtained as output from the first generative AI model.

Motifs may be obtained for the perturbated outputs. The motifs may include portions of the perturbated outputs that occur repeatedly among the perturbated outputs. The motifs may include: (i) a topic, (ii) a phrase, (iii) a paragraph, (iv) a sub-chapter, and/or any other combination of one or more tokens. The tokens may include: (i) words, (ii) punctuation marks, (iii) phrases, (iv) letters, and/or (v) portions of other types of data modalities (e.g., pixels of an image).

An output alignment optimization process may be performed using an output alignment optimization schema and the motifs to obtain aligned motifs. The aligned motifs may include one or more re-ordered motifs of the motifs. Motifs may be re-ordered to increase alignment between different perturbated outputs of the perturbated outputs.

Performing the output alignment optimization process may include: (i) identifying, using the output alignment optimization schema, a motif consensus, the motif consensus indicating a most common ordering for the motifs, (ii) re-ordering, based on the motif consensus and the output alignment optimization schema, motifs of one or more of the perturbated outputs to obtain re-ordered outputs, (iii) shifting, using the output alignment optimization schema, portions of the re-ordered outputs to increase alignment between placement of the portions of the re-ordered outputs to generate the aligned outputs, and/or (iv) other methods.

An extent of re-ordering of the motifs may be guided by the output alignment optimization schema. For example, the output alignment optimization schema may include an objective function that proportionally penalizes re-ordering based on the extent of the re-ordering.

Variability information may be obtained based on the aligned outputs. The variability information may include: (i) differences between portions of a first aligned output of the aligned outputs and other aligned outputs of the aligned outputs, (ii) frequencies of occurrence for motifs of the first aligned output in the other aligned outputs, and/or (iii) other information.

The variability information and the aligned outputs may be used to populate a graphical user interface (GUI). The GUI may be accessible by a downstream consumer and the downstream consumer may, therefore, be able to interact with the aligned outputs, select one or more of the aligned outputs, and view variability information indicating stability of portions of the aligned outputs.

Thus, embodiments disclosed herein may improve processes of explaining outputs generated by generative AI models to downstream consumers of the outputs. By iteratively perturbating prompts and aligning the perturbated outputs generated using the perturbated prompts, variability information for portions of the output may be obtained and, therefore, transparency of decision-making by the generative AI model may be increased.

To provide the above noted functionality, the system of FIG. 1 may include data processing systems 100, AI model manager 102, downstream consumers 106, and communication system 104. Each of these components is discussed below.

Data processing systems 100 may provide all, or a portion of, the computer-implemented services. Data processing systems 100 may include any number of data processing systems (e.g., 100A-100N) that may provide output generation services to downstream consumers 106. For example, a downstream consumer (e.g., 106A) may subscribe to output generation services provided by data processing system 100A and downstream consumer 106A may provide prompts (e.g., from clients, from owners of downstream consumer 106A, from employees of a company that owns downstream consumer 106A) to data processing system 100A as part of the subscribed services.

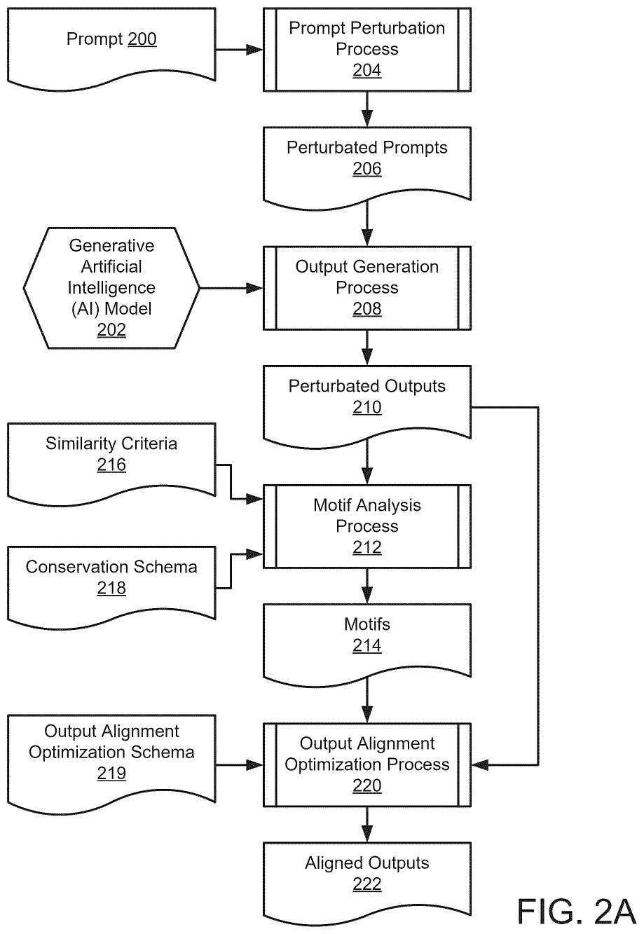

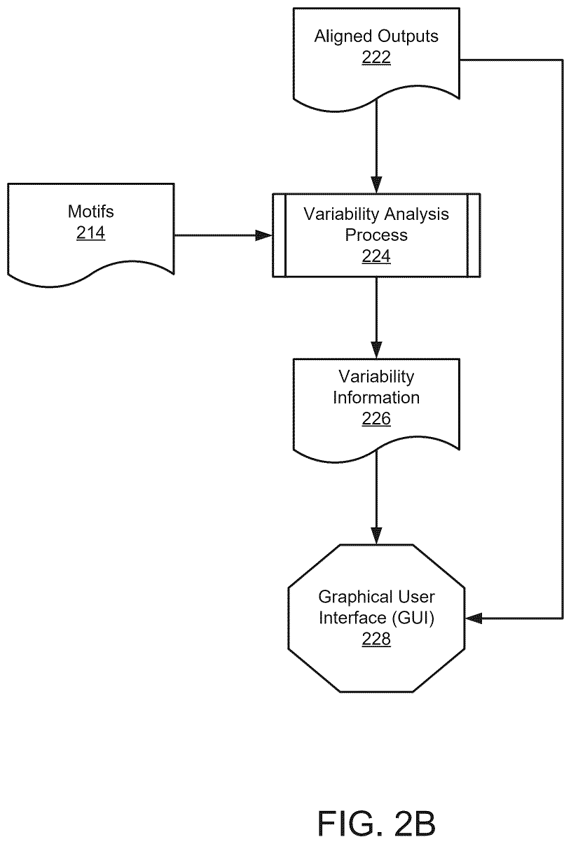

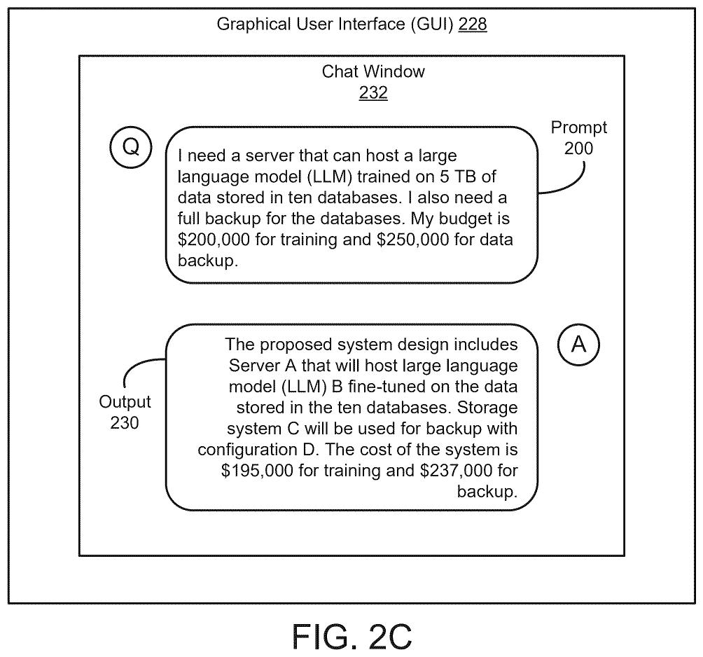

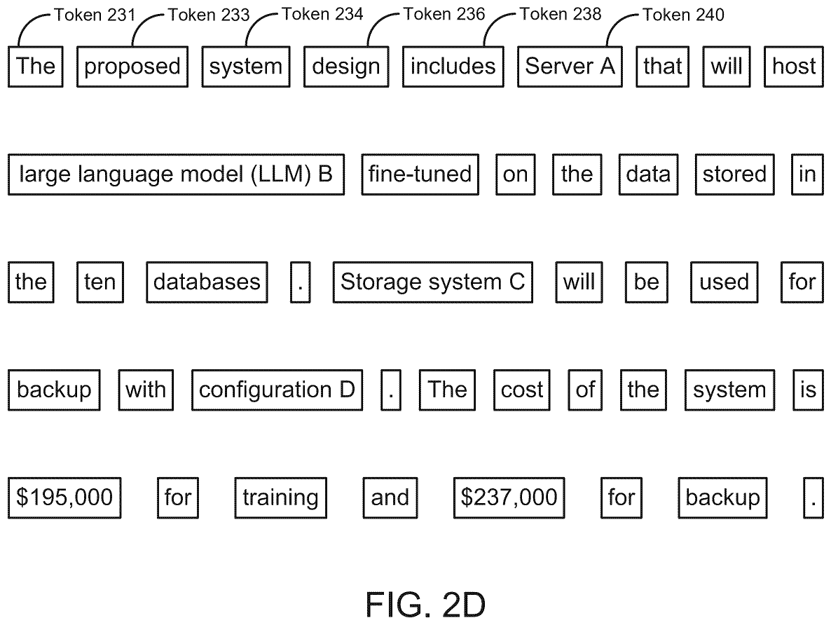

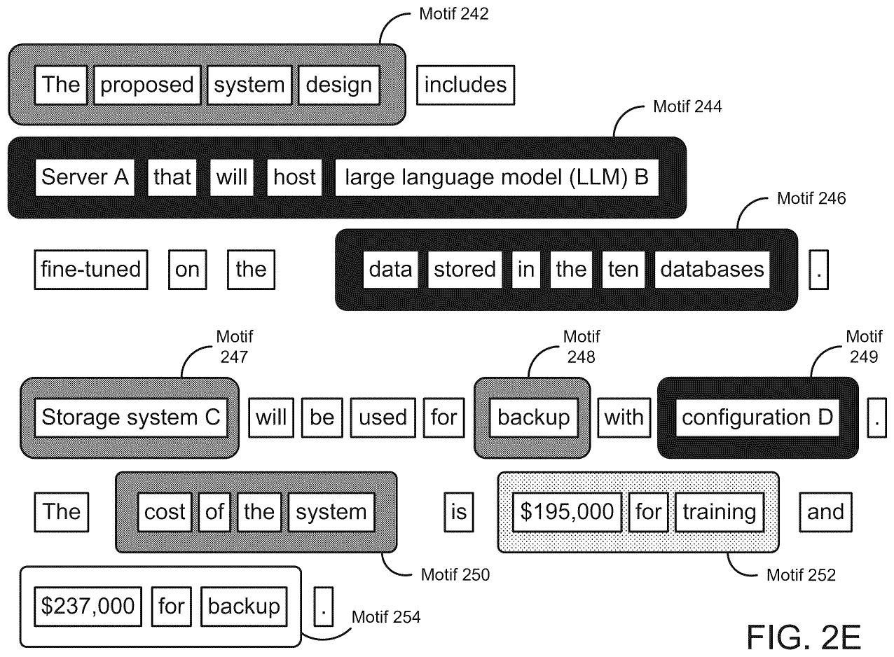

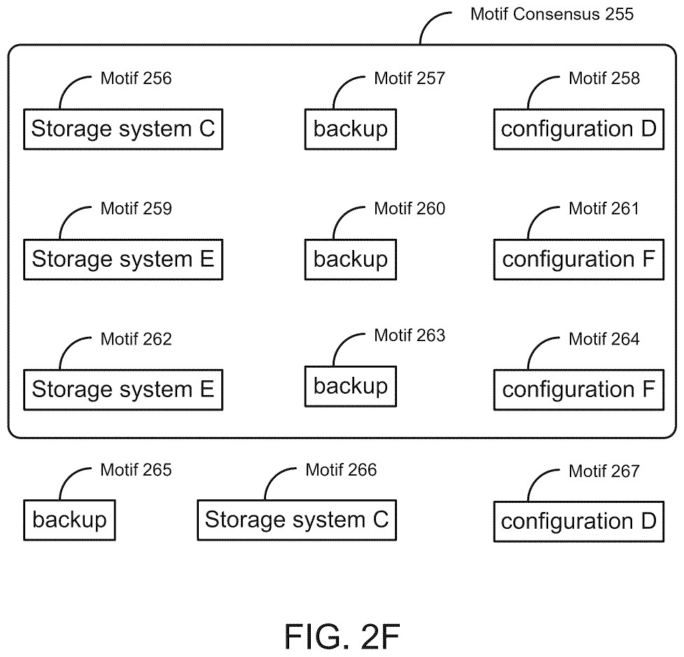

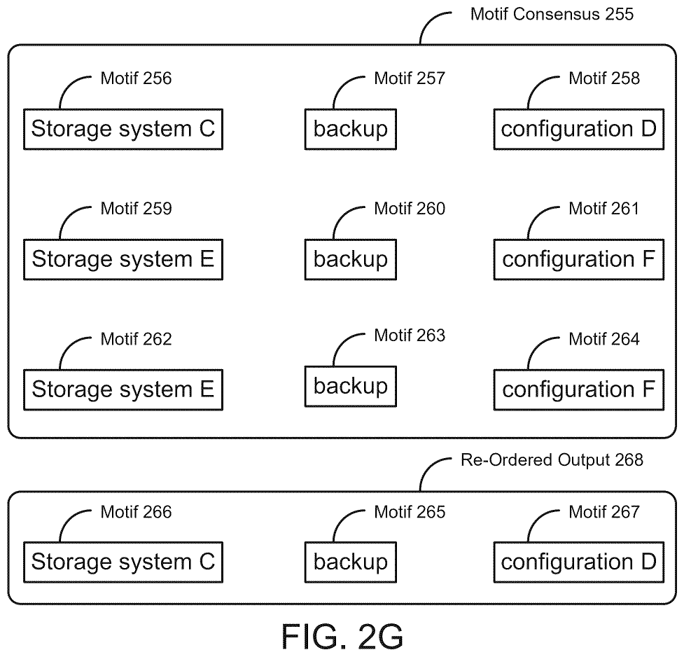

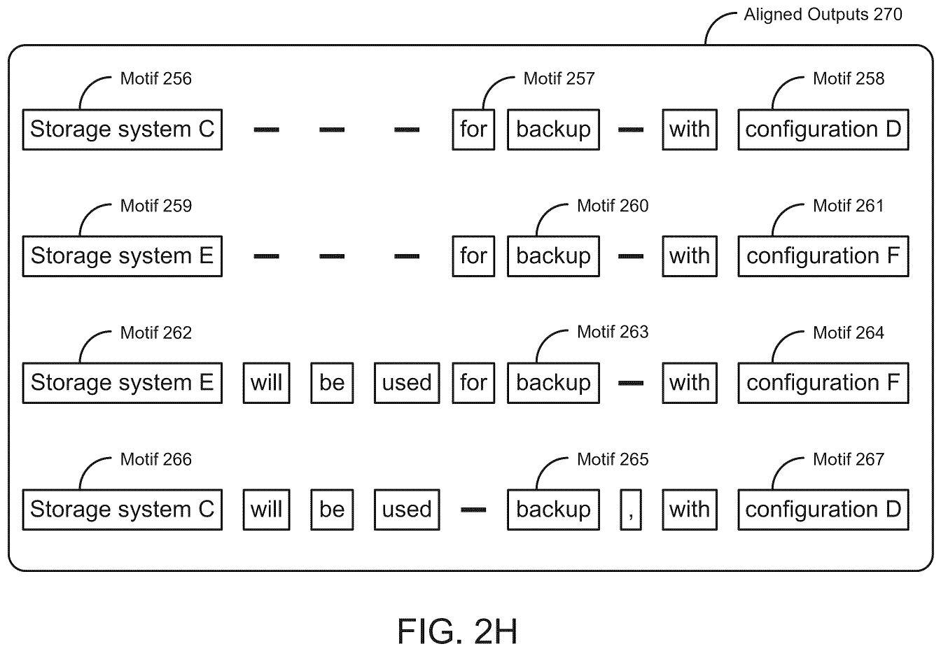

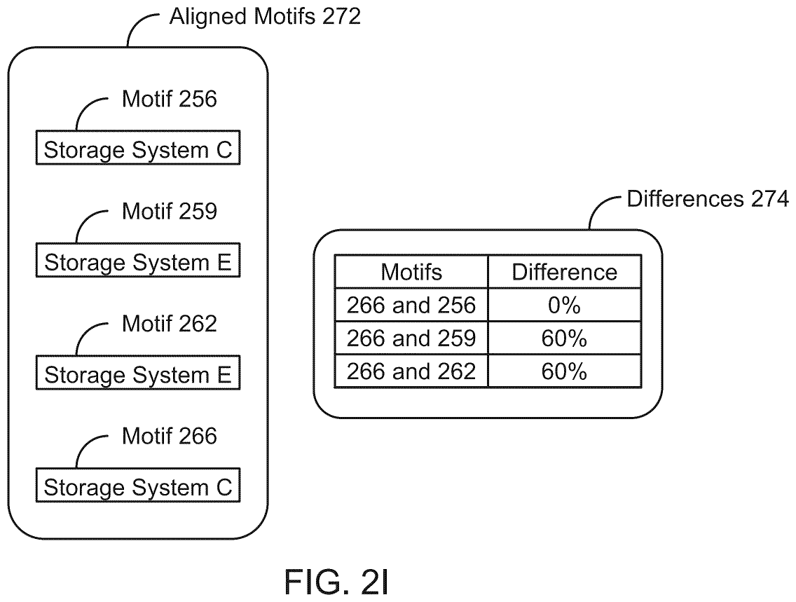

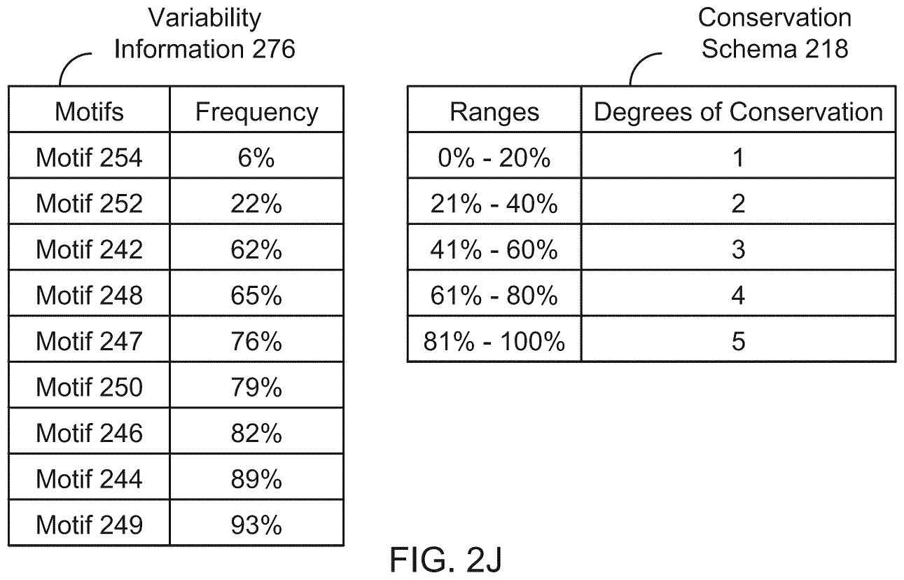

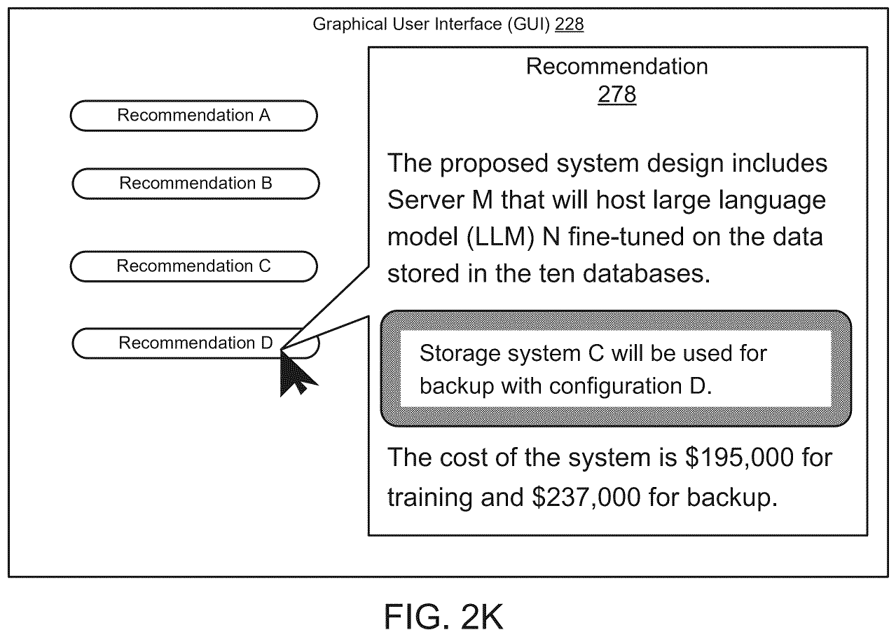

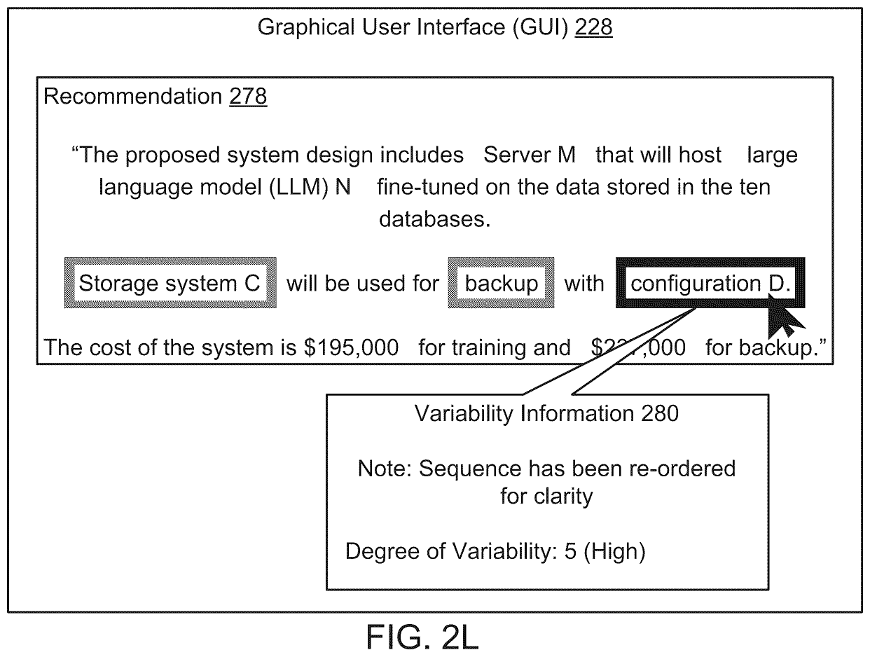

To provide computer-implemented services, data processing systems 100 may: (i) obtain prompts for generative AI models (e.g., hosted and/or operated by data processing systems 100), (ii) iteratively perturbate the prompt to obtain perturbated prompts, (iii) feed the perturbated prompts into a generative AI model to obtain perturbated outputs, (iv) obtain motifs for the perturbated prompts, (v) perform output alignment optimization processes using an output alignment optimization schema to obtain aligned outputs, (vi) compare the aligned outputs to obtain variability information for portions of the perturbated outputs, (vii) populate graphical user interfaces (GUIs) using the aligned outputs and/or the variability information as part of providing computer-implemented services to downstream consumers, (viii) select and/or perform actions based on the variability information and/or the aligned outputs, and/or (ix) perform other actions. Refer to FIG. 2A for additional details regarding obtaining motifs for perturbated outputs and performing output alignment optimization processes.

AI model manager 102 may manage any number of AI models. For example, AI model manager 102 may: (i) obtain training data for AI models, (ii) train any number of AI models to obtain trained AI models, (iii) deploy trained AI models to other entities (e.g., data processing systems 100), (iv) update and/or modify trained AI models (e.g., fine-tune trained AI models based on additional training and/or production data), and/or (v) provide other AI model management services.

For example, AI model manager 102 may cooperatively provide at least a portion of the computer-implemented services to data processing systems 100 by: (i) obtaining training data from downstream consumers 106, (ii) training one or more AI models (e.g., generative AI models) using at least the training data obtained from downstream consumers 106 to obtain one or more trained AI models, (iii) deploying the one or more trained AI models to data processing systems 100 for use in providing output generation services for downstream consumers 106, and/or (iv) performing other actions.

Downstream consumers 106 may provide and/or consume all, or a portion of, the computer-implemented services. Downstream consumers 106 may include any number of downstream consumers (e.g., 106A-106N) and may include, for example, businesses, individuals, and/or devices (e.g., data processing systems) that may obtain outputs and/or other information based on the outputs as part of receiving the computer-implemented services.

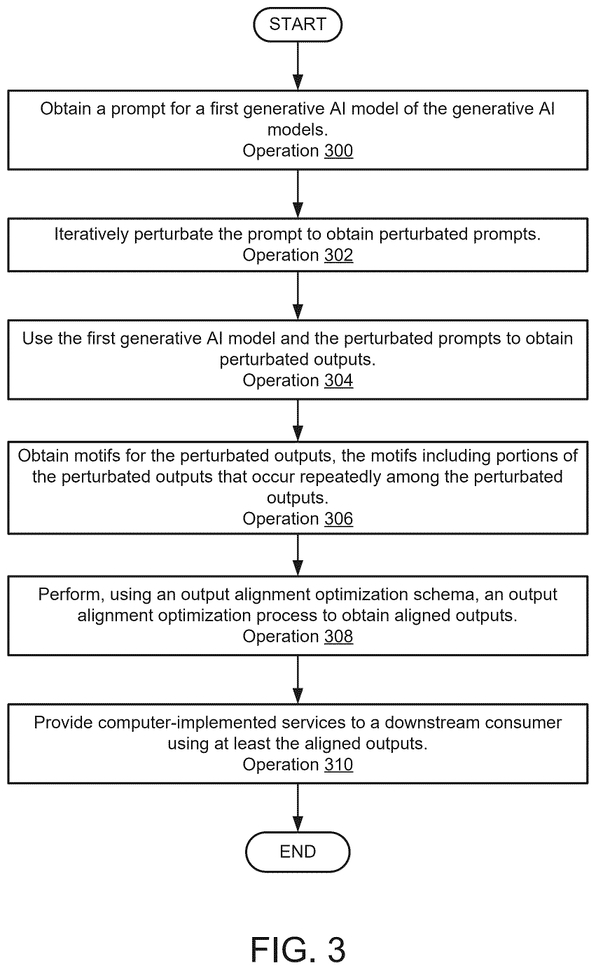

When providing their functionality, any of (and/or components thereof) data processing systems 100, AI model manager 102, and/or downstream consumers 106 may perform all, or a portion, of the actions and methods illustrated in FIGS. 2A-3.

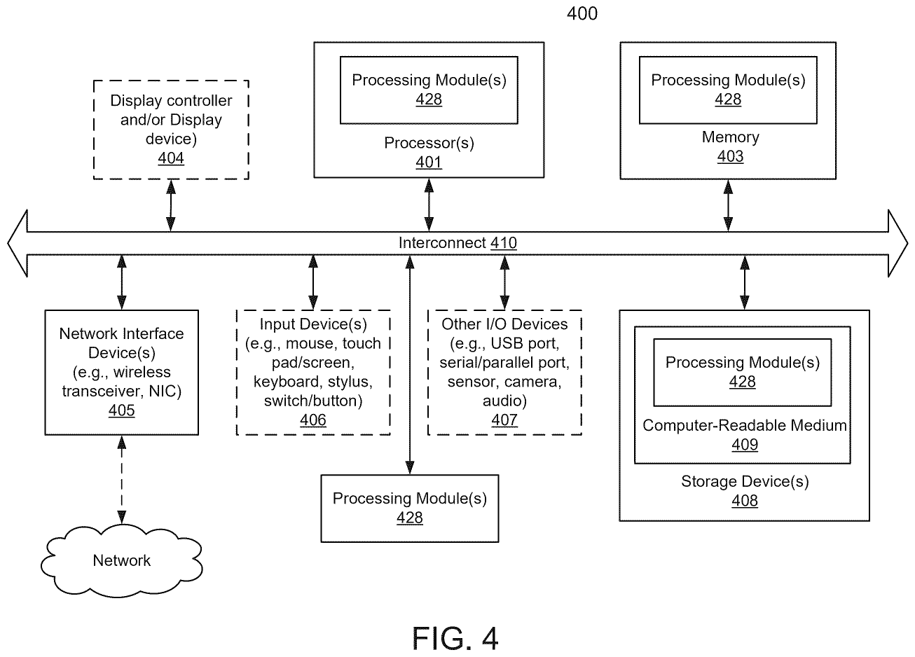

Any of (and/or components thereof) data processing systems 100, AI model manager 102, and downstream consumers 106 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to the discussion of FIG. 4.

Any of the components illustrated in FIG. 1 may be operably connected to each other (and/or components not illustrated) with communication system 104. In an embodiment, communication system 104 includes one or more networks that facilitate communication between any number of components. The networks may include wired networks and/or wireless networks (e.g., and/or the Internet). The networks may operate in accordance with any number and types of communication protocols (e.g., such as the internet protocol).

Communication system 104 may allow any of data processing systems 100, AI model manager 102, and downstream consumers 106 to communicate with one another (and/or with other devices not illustrated in FIG. 1). To provide its functionality, communication system 104 may be implemented with one or more wired and/or wireless networks. Any of these networks may be a radio access network (e.g., a cellular core network), a private network (e.g., the “Network” shown in FIG. 4), a public network, and/or may include the Internet. For example, data processing systems 100 may be operably connected to AI model manager 102 and downstream consumers 106 via the Internet. Data processing systems 100, AI model manager 102, downstream consumers 106, and/or communication system 104 may be adapted to perform one or more protocols for communicating via communication system 104.

While illustrated in FIG. 1 as including a limited number of specific components, a system in accordance with an embodiment may include fewer, additional, and/or different components than those illustrated therein.

While providing their functionality, any of data processing systems 100, AI model manager 102, and/or downstream consumers 106 may provide all or a portion of the methods shown in FIGS. 2A-3.

To further clarify embodiments disclosed herein, a data flow diagram in accordance with an embodiment is shown in FIG. 2A. In this diagram, flows of data and processing of data are illustrated using different sets of shapes. A first set of shapes (e.g., 200, 206, etc.) is used to represent data structures, a second set of shapes (e.g., 204, 208 etc.) is used to represent processes performed using and/or that generate data, a third set of shapes (e.g., 202) is used to represent generative AI models, and/or other types of models, and a fourth set of shapes (e.g., 228) is used to represent graphical user interfaces (GUIs).

Turning to FIG. 2A, a first data flow diagram in accordance with an embodiment is shown. The first data flow diagram may illustrate data used in and data processing performed in aligning generative AI model outputs to obtain aligned outputs (e.g., aligned outputs 222).

To obtain aligned outputs 222, at least prompt perturbation process 204, output generation process 208, motif analysis process 212, and output alignment optimization process 220 may be performed.

During prompt perturbation process 204, prompt 200 may be iteratively perturbated to obtain perturbated prompts 206. Prompt 200 may be intended to elicit an output from a generative AI model (e.g., generative AI model 202) that includes information content desired by downstream consumer 106A (e.g., prompt 200 may be obtained from downstream consumer 106A, refer to FIG. 1 for details regarding downstream consumer 106A). Prompt 200, for example, may include human-interpretable text and may include a question. For example, prompt 200 may include: (i) a request from a user for help assessing a malfunction of a computer system, (ii) a request from a customer for a product recommendation, (iii) a request from an employee of a business for a recommendation regarding a financial product (e.g., whether to extend a line of credit to a customer), and/or (iv) other requests. Refer to FIG. 2C for an example of prompt 200.

During prompt perturbation process 204, a first information element (e.g., one or more tokens) of prompt 200 may be modified (e.g., removed, replaced with a replacement information element) to obtain a first perturbated prompt. The first information element may be selected based on: (i) a policy, (ii) an information element replacement schema, (iii) user feedback (e.g., a client may select the information element via a GUI), and/or (iv) via other methods.

The information elements of prompt 200 may include any item, object, or entity in prompt 200 and the information elements may be identified via any algorithm, machine learning model, and/or rule set for natural language processing to extract information from text. Information elements may be extracted from other types of data modalities (e.g., images, audio, video) via object recognition algorithms or models. Information elements may be obtained via other methods without departing from embodiments disclosed herein.

For example, prompt 200 may include the following text: “My computer is not working. It keeps re-starting and overheating. I have computer A and I use operating system B, monitor C, keyboard D, and mouse E. How do I fix it?” The first information elements extracted from prompt 200 may, therefore, include: (i) computer A, (ii) operating system B, (iii) monitor C, (iv) keyboard D, (v) mouse E, (vi) not working, (vii) re-starting, and (viii) overheating.

The information elements may be stored as a list, as a graphical representation of the information elements, as human-interpretable text that summarizes the information elements, and/or in other formats. The information elements (e.g., the human-interpretable text, the graphical representation, the list) may be published to a client portal and may be accessible by a downstream consumer via a graphical user interface (GUI).

Continuing with the above example, information elements of prompt 200 may be iteratively removed (e.g., one information element may be removed at a time) to generate any number of perturbated prompts (e.g., 206). For example, the information element “operating system B” may be removed from prompt 200 to obtain a perturbated prompt that includes the following text: “My computer is not working. It keeps re-starting and overheating. I have computer A and I use monitor C, keyboard D, and mouse E. How do I fix it?”

Prompt 200 may also be modified, for example, by replacing the first information element with a replacement information element (e.g., provided by a user via a GUI, obtained using a retrieval augmented generation (RAG) process and any number of data sources) to obtain the perturbated prompt. For example, the information element “monitor C” may be replaced with a replacement information element “monitor K” to generate a perturbated prompt that includes the following text: “My computer is not working. It keeps re-starting and overheating. I have computer A and I use operating system B, monitor K, keyboard D, and mouse E. How do I fix it?”

Perturbated prompts 206 and generative AI model 202 may be used to perform output generation process 208. For example, generative AI model 202 may be an LLM (e.g., a neural network inference model) trained to generate language, understand language, and/or otherwise process requests related to languages. Generative AI model 202 may have been previously trained using training data and any training process (e.g., a global optimization process using gradient descent), the training data indicating goals for outputs generated by generative AI model 202 (e.g., outputs). Parameters of generative AI model 202 may be selected using an optimization process (e.g., an objective function may be defined in terms of the training data and outputs generated by generative AI model 202, and a global optimization method such as gradient descent may be used to identify parameters that most faithfully reproduce the trends in the training data). Once the parameters of generative AI model 202 are set, then generative AI model 202 may be used to generate outputs (e.g., responses) based on input data (e.g., prompts). Generative AI model 202 may be trained using other methods without departing from embodiments disclosed herein.

During output generation process 208, perturbated prompts 206 may be provided as ingest to generative AI model 202 and perturbated outputs 210 may be obtained as outputs from generative AI model 202. Output generation process 208 may also include performing retrieval-augmented generation (RAG) processes to augment perturbated prompts 206 with data sources relevant to each of perturbated prompts 206.

Each perturbated output of perturbated outputs 210 may include tokens (e.g., generated by generative AI model 202 during output generation process 208. The tokens may include: (i) words, (ii) letters, (iii) punctuation marks, (iv) phrases, and/or (v) other components of perturbated outputs 210. For example, a first perturbated output may include the following text: “We recommend re-installing driver F and disconnecting and re-connecting all Bluetooth devices.” Tokens of the first perturbated output, therefore, may include: (i) “we,” (ii) “recommend,” (iii) “re-installing,” (iv) “driver F,” (v) “and,” (vi) “disconnecting,” (vii) “re-connecting,” (viii) “all,” and (ix) “Bluetooth devices.” Tokens may include other tokens (e.g., “Bluetooth” and “devices” may be separate tokens, “.” may be an additional token).

Information elements of perturbated outputs 210 may include one or more tokens (e.g., “driver F” may also be an information element).

Perturbated outputs 210, similarity criteria 216, and conservation schema 218 may be used to perform motif analysis process 212. During motif analysis process 212, a first sequence of tokens corresponding to a first perturbated output of perturbated outputs 210 may be obtained. The first sequence of tokens may be compared, using similarity criteria 216, to other perturbated outputs of perturbated outputs 210 to obtain motifs 214 and degrees of conservation for motifs 214 (not shown). For example, the tokens “re-installing” and “driver F” from the previous example may be grouped (e.g., using an algorithm such as one adapted from Multiple Expectation Maximums for Motif Elicitation (MEME), manually by a subject matter expert) to obtain a first motif. Refer to FIG. 2D for an example of tokens of a perturbated output.

Other perturbated outputs of perturbated outputs 210 may be searched, using similarity criteria 216, to identify occurrences of the first motif in the other perturbated outputs. Similarity criteria 216 may indicate, for example, an acceptable deviation in information content of the motifs for the occurrences to be considered same motifs as the first motif. Similarity criteria 216 may include a threshold amount of deviation (e.g., of 10%) in order to increase a likelihood that different phrasings of a same motif, different orderings of tokens in a same motif, and/or otherwise motifs that include slight deviations from the first motif are identified during the searching process.

For example, a second motif in a second perturbated output of perturbated outputs 210 may include the phrase “driver F is to be re-installed.” The second motif may meet similarity criteria 216 to be considered a same motif as the first motif.

Therefore, a frequency of occurrences of the first motif may be obtained (e.g., the first motif may appear in 82% of perturbated outputs 210. Each motif of motifs 214 may be assigned a frequency of occurrence as described with respect to the first motif. Refer to FIG. 2J for an example of a set of frequences of occurrences for motifs of a perturbated output.

Conservation schema 218 may define a process for assigning degrees of conservation to motifs based on frequencies of occurrence for the motifs. For example, the process may scale the degrees of conservation with the frequencies of occurrence (e.g., the degrees of conservation may increase as the frequencies of occurrence increase). In addition, the process may utilize bucketized ranges of the frequencies of occurrence so that each bucketized range of the bucketized ranges is associated with a degree of conservation of the degrees of conservation.

For example, five bucketized ranges may be defined by conservation schema 218. The bucketized ranges may include: (i) 0%-20%, (ii) 21%-40%, (iii) 41%-60%, (iv) 61%-80%, and (v) 81%-100%). Each bucketized range may be associated with a different degree of conservation. For example, if a motif appears in 15% of perturbated outputs 210, the motif may be assigned a degree of conservation of 1 (e.g., on a scale of 1-5 where 1 represents the lowest degree of conservation and 5 represents the highest degree of conservation). A higher degree of conservation may indicate a higher degree of stability for a portion of an output associated with a particular motif.

While described with regard to percentages and a scale between 1-5, frequencies of occurrences and degrees of conservation respectively may be represented in other ways without departing from embodiments disclosed herein.

Therefore, motifs 214 may include a list of motifs for each perturbated output of perturbated outputs 210 and corresponding degrees of conservation for each motif of motifs 214.

Motifs 214, perturbated outputs 210, and output alignment optimization schema 219 may be used to perform output alignment optimization process 220. During output alignment optimization process 220, portions of perturbated outputs 210 may be: (i) re-ordered, and/or (ii) shifted (e.g., gaps may be inserted between the portions) to increase alignment between the portions of perturbated outputs 210.

During output alignment optimization process 220, a motif consensus may be obtained for motifs of motifs 214. The motif consensus may include, for example, a most common ordering for at least a portion of motifs 214.

For example, a first perturbated output of perturbated outputs 210 may include: (i) a first motif including the text “we recommend,” (ii) a second motif including the text “re-installing driver F,” and (iii) a third motif including the text “disconnecting and re-connecting all Bluetooth devices.” A majority of perturbated outputs 210 (e.g., 80%) may include the first, second, and third motif in the following order: (i) first motif, (ii) second motif, and (iii) third motif. A minority of perturbated outputs 210 (e.g., the other 20%) may include a different ordering of the motifs (e.g., first motif, third motif, second motif). In addition, at least a portion of the 20% of perturbated outputs 210 may not include one or more of the three motifs.

Therefore, a motif consensus for the motifs of the first perturbated output may indicate: (i) the first motif first, (ii) the second motif second, and (iii) the third motif third.

Therefore, during output alignment optimization process 220, perturbated outputs of perturbated outputs 210 that do not match the motif consensus may be re-ordered. Motifs may be re-ordered, for example, so that an ordering of the motifs matches (e.g., to an extent considered acceptable using at least output alignment optimization schema 219) the motif consensus for the motifs.

In addition, during output alignment optimization process 220, the re-ordered motifs may be shifted (e.g., using a mathematical formulation) to increase alignment between portions of the re-ordered motifs. For example, gaps may be inserted between the portions and/or placement of the portions may be shifted to increase alignment between the portions.

Output alignment optimization schema 219 may define an acceptable extent of re-ordering and/or shifting of the portions. For example, the processes of re-ordering and/or shifting placement of portions of perturbated outputs 210 may impact information content and/or comprehensibility of perturbated outputs 210. Specifically, as a degree of alteration of a perturbated output increases, a likelihood of manipulation of information content of the perturbated output may also increase.

Therefore, to limit unintended alteration of information content of the perturbated outputs, output alignment optimization schema 219 may include an objective function that proportionally penalizes re-ordering of motifs and/or other information elements of perturbated outputs 210 based on an extent of the re-ordering. Goals may be defined for the objective functions (e.g., for minimizing the objective function) so that re-ordering is not performed to an extent that exceeds the goals (e.g., if the objective function is not minimized to an extent indicated by the goal, one or more re-orderings may not be performed).

By doing so, aligned outputs 222 may be generated while reducing a likelihood of obscuring and/or unintentionally modifying information content of aligned outputs 222. Consequently, computer-implemented services provided using at least aligned outputs 222 may have an increased likelihood of meeting expectations of downstream consumers.

Turning to FIG. 2B, a second data flow diagram in accordance with an embodiment is shown. The second data flow diagram may illustrate data used in and data processing performed in providing computer-implemented services to downstream consumers using at least aligned outputs 222.

As part of providing the computer-implemented services, at least variability analysis process 224 may be performed. During variability analysis process 224, motifs 214 and aligned outputs 222 may be analyzed to obtain variability information 226. Variability analysis process 224 may include methods similar to those described with respect to obtaining frequencies of occurrences for motifs 214 (e.g., described in FIG. 2A) and/or degrees of conservation for motifs 214. Therefore, variability information 226 may include the frequencies of occurrence and/or the degrees of conservation for each of motifs 214. Refer to FIG. 2J for additional details regarding obtaining frequencies of occurrence and/or degrees of conservation for motifs.

During variability analysis process 224, aligned outputs 222 may be compared to obtain differences between corresponding (e.g., aligned) portions of aligned outputs 222. The portions of aligned outputs 222 may include: (i) motifs of aligned outputs 222, (ii) tokens of aligned outputs 222, (iii) information elements (e.g., including one or more tokens) of aligned outputs 222, and/or (iv) other portions. For example, a first sub-set of the differences may include differences between a first token of a first aligned output of aligned outputs 222 and a corresponding token of each of the other aligned output of aligned outputs 222.

The differences may be obtained using any similarity measure (e.g., differences between numerical values, Manhattan distance, cosine similarity, radial basis function kernel) between the portions in the aligned outputs. The differences may be obtained using graphical representations of aligned outputs 222. A graphical representation may include: (i) nodes that represent portions of the aligned outputs (e.g., tokens, information elements), and (ii) edges that represent relationships between the nodes. Therefore, the differences also may be calculated using any graph comparison algorithm.

Degrees of variability (not shown) may be obtained using the differences. For example, the differences may be used to generate any number of aggregated statistics related to variability of the portions of aligned outputs 222. For example, if the differences include a set of Manhattan distances between a first token and corresponding tokens of other sequences in aligned outputs 222, obtaining the degrees of variability may include calculating: (i) a range of the Manhattan distances, (ii) a standard deviation for the Manhattan distances, (iii) a variance for the Manhattan distances, and/or (iv) other indications of variability based on the Manhattan distances. The range, standard deviation, and variance may be included variability information 226.

Variability analysis process 224 may include obtaining other information related to stability of the portions of aligned outputs 222 without departing from embodiments disclosed herein.

Graphical user interface (GUI) 228 may be populated using at least variability information 226 to obtain a populated GUI. GUI 228 may be accessible by downstream consumers (e.g., via a website) and may include any number of pop-up interfaces, chat windows, buttons, graphics, and/or other elements through which information may be displayed to a viewer (e.g., a downstream consumer) and/or through which the viewer may interact. Refer to FIGS. 2K-2L for examples of information that may be displayed to a user via GUI 228.

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the data structures illustrated using the first set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

Thus, by implementing the data flows shown in FIGS. 2A-2B, a system in accordance with embodiments disclosed herein may be used to generate: (i) aligned outputs from generative AI models based on prompts and (ii) variability information for portions of the aligned outputs. By iteratively perturbating prompt 200, generating perturbated outputs based on the perturbated prompts, and aligning the perturbated outputs via re-ordering and/or shifting placement of portions of the perturbated outputs, the variability information may be generated to indicate stability of the portions of the perturbated outputs. Consequently, a reliability and/or usefulness of outputs may be increased for the downstream consumer.

Turning to FIG. 2C, an example of prompt 200 and output 230 (e.g., one of perturbated outputs 210 described in FIG. 2A) are shown. A customer (e.g., downstream consumer 106A described in FIG. 1) may access graphical user interface (GUI) 228 through which the customer may receive assistance with a product recommendation request. A customer may open chat window 232 as part of functionality of GUI 228 and may enter prompt 200 into the chat window. Prompt 200 may include the following text: “I need a server that can host a large language model (LLM) trained on 5 terabytes (TB) data stored in ten databases. I also need a full backup for the databases. My budget is $200,000 for training and $250,000 for data backup.” Prompt 200 is shown next to a circle with the letter “Q” inside the circle to indicate a question from the customer that was submitted via chat window 232.

Output 230 may include the following text: “The proposed system design includes Server A that will host large language model (LLM) B fine-tuned on the data stored in the ten databases. Storage system C will be used for backup with configuration D. The cost of the system is $195,000 for training and $237,000 for backup.” Output 230 is shown next to a circle with the letter “A” inside the circle to indicate an answer from the manufacturer/vendor for the product (e.g., via the generative AI model). Output 230 may be visible to the customer via chat window 232.

To provide variability information to the downstream consumer, prompt 200 may be iteratively perturbated (e.g., modified) as described in prompt perturbation process 204 in FIG. 2A. The perturbated prompts may be fed into the generative AI model (e.g., 202) to obtain perturbated outputs as described in output generation process 208 in FIG. 2A.

Turning to FIG. 2D, an example of tokens of output 230 (e.g., described in FIG. 2C) is shown. Tokens of output 230 may be generated by a generative AI model and may include: (i) a word, (ii) a phrase, (iii) a punctuation mark, (iv) a letter, and/or (v) other portions of output 230. For example, tokens 231, 233, 234, 236, 238, and 240 are labeled in FIG. 2D. Token 231 may include the word “the,” token 233 may include the word “proposed,” token 234 may include the word “system,” token 236 may include the word “design,” token 238 may include the word “includes,” and token 240 may include the phrase “Server A.”

Turning to FIG. 2E, an example of motifs of output 230 obtained based on tokens of output 230 is shown. Motif 242 may include tokens 231, 233, 234, and 236 (shown in FIG. 2C). Motifs may be generated using a motif discovery algorithm (e.g., one adapted from MEME) and/or may be generated via other methods.

For each motif, a consensus sequence may be generated as an identifier for the motif. For example, a consensus sequence for motif 250 may include the text “the system costs.” The tokens shown in FIG. 2E as part of motif 250 may, therefore, be considered sufficiently similar (e.g., based on similarity criteria 216) to the consensus sequence for motif 250. The consensus sequence for motif 250 may be generated based on a majority of instances of motif 250 including the consensus sequence ordering of the tokens or may be based on an output generated using the original prompt (e.g., an un-perturbated version of the prompt).

For example, motif 244 may include the tokens “Server A,” “that,” “will,” “host,” and “large language model (LLM) B.” Motif 246 may include the tokens “data,” “stored,” “in,” “the,” “ten,” and “databases.” Motif 247 may include the token “storage system C.” Motif 248 may include the token “backup.” Motif 249 may include the token “configuration D.” Motif 250 may include the tokens “cost,” “of,” “the,” and “system.” Motif 252 may include the tokens “$195,000,” “for,” and “training.” Motif 254 may include the tokens “$237,000,” “for,” and “backup.” Each motif may also include a corresponding consensus sequence for reference by a user (e.g., upon selection of a motif, the consensus sequence may appear in a pop-up window on a GUI).

In FIG. 2E, each motif is shown surrounded by a shape with a degree of shading. The degrees of shading for the shapes may represent degrees of conservation for the motifs (e.g., refer to the description of FIG. 2B for additional details regarding degrees of conservation). Refer to FIG. 2J for an example of frequencies of occurrence and degrees of conservation for motifs.

Turning to FIG. 2F, an example of motifs of four perturbated outputs (e.g., of perturbated outputs 210 described in FIG. 2A) is shown. Three corresponding motifs for each perturbated output are shown for clarity, while the four perturbated outputs may include any number of additional motifs and/or information elements without departing from embodiments disclosed herein.

The first perturbated output may include motif 256, motif 257, and motif 258. The second perturbated output may include motif 259, motif 260, and motif 261. The third perturbated output may include motif 262, motif 263, and motif 264. The fourth perturbated output may include motif 265, motif 266, and motif 267.

Motifs 256, 259, 262, and 266 may be a first same motif (e.g., may include corresponding information content such as a type of storage system). Motifs 257, 260, 263, and 265 may be a second same motif (e.g., may include the text “backup”). Motifs 258, 261, 264, and 267 may be a third same motif (e.g., may include types of configurations for the storage system).

The first, second, and third perturbated outputs may have a first ordering of the three motifs (e.g., the first same motif, the second same motif, and the third same motif). The fourth perturbated output may have a second ordering of the three motifs (e.g., the second same motif, the first same motif, and the third same motif).

As a majority of the shown perturbated outputs have the first ordering, the first ordering may be used as the motif consensus for the three motifs. The first, second, and third perturbated outputs are shown surrounded by a shape to indicate that they follow the motif consensus (e.g., motif consensus 255).

Turning to FIG. 2G, the fourth perturbated output (e.g., described in FIG. 2F) may be re-ordered based on motif consensus 255 (e.g., described in FIG. 2F) to obtain re-ordered output 268. In re-ordered output 268, corresponding motifs may have a same ordering as motif consensus 255 (e.g., the first same motif, the second same motif, the third same motif).

Turning to FIG. 2H, an example of aligned outputs (e.g., aligned outputs 270) is shown. Aligned outputs 270 may include the four perturbated outputs described in FIGS. 2F-2G. Aligned outputs 270 may include additional information from the four perturbated outputs not included in FIGS. 2F-2G (e.g., additional information elements).

For example, the first perturbated output may include the text “storage system C for backup with configuration D.” The words “for” and “with” may be tokens of the first perturbated output that were not included in FIGS. 2F-2G for clarity (e.g., only the ordering of motifs was shown). The second perturbated output may include the text “storage system E for backup with configuration F.” The third perturbated output may include the text “storage system E will be used for backup with configuration F.”

Motifs of the fourth perturbated output (e.g., motif 266, motif 265, and motif 267) may have been re-ordered as described in FIG. 2G. Therefore, the fourth perturbated output may include the text “storage system C will be used backup, with configuration D.” The sequence of tokens may include grammatical errors due to the re-ordering of the motifs. Similar grammatical and/or coherency issues may be addressed by feeding re-ordered motifs into a generative AI model (e.g., an LLM) as part of a prompt requesting readability be increased for a re-ordered output.

An alignment process may be performed, using a mathematical formulation, to generate aligned outputs 270. Therefore, motifs 256, 259, 262 and 266 have been aligned vertically to indicate that the tokens are related. Aligned outputs 270 may be generated relative to one of the perturbated outputs. For example, the fourth perturbated output (e.g., including motifs 266, 265, and 267) may be the reference output and the other perturbated outputs may be aligned relative to the fourth output. Therefore, gaps may be inserted (e.g., between the token “for” and motif 257 in the first perturbated output.

Aligned outputs 270 may be used to generate differences between corresponding tokens and/or motifs (e.g., a difference between motif 256 and motif 259, a difference between motif 256 and motif 262). Refer to FIG. 2I for an example of generating differences between motifs and/or tokens.

Turning to FIG. 2I, an example of differences between corresponding motifs of aligned outputs 270 is shown. Aligned motifs 272 shows motif 256, motif 259, motif 262, and motif 266 from aligned outputs 270. Differences 274 may be generated based on aligned motifs 272. Motif 266 may be part of the fourth aligned output of aligned outputs 270 shown in FIG. 2H and, therefore, differences 274 may be generated relative to motif 266.

For example, differences 274 may include a first difference between motif 266 and motif 256 (e.g., 0%), a second difference between motif 266 and motif 259 (e.g., 60%), and a third difference between motif 266 and motif 262 (e.g., 60%). In FIG. 2I, differences 274 are shown as percent differences. However, differences between tokens may be generated via other methods without departing from embodiments disclosed herein.

Turning to FIG. 2J, an example of frequencies of occurrences for the motifs shown in FIG. 2E is shown as variability information 276. In the left-hand column of variability information 276, labels for the motifs shown in FIG. 2E are displayed. In the right-hand column of variability information 276, corresponding occurrence frequencies for each motif are shown. The motifs are ordered based so that the occurrence frequencies increase down the right-hand column.

An example of conservation schema 218 (e.g., described in FIG. 2A) is also shown in FIG. 2J. Conservation schema 218 may also include two columns. The left-hand column of conservation schema 218 may include bucketized ranges for frequencies of occurrence for motifs. The right-hand side of conservation schema 218 may include corresponding degrees of conservation that are assigned to motifs based on which bucketized range a frequency of occurrence for a motif falls within.

The degrees of shading shown in FIG. 2E may be based on the degrees of conservation assigned to the motifs. For example, motif 254 may have a frequency (e.g., frequency of occurrence) that falls within the first bucketized range of 0%-20% and, therefore, may have a first degree of shading (e.g., no shading) that corresponds to a degree of conservation of 1. Motif 252 may have a frequency that falls within the second bucketized range of 21%-40% and, therefore, may have a second degree of shading that corresponds to a degree of conservation of 2. Motif 242, motif 248, motif 247 and motif 250 may have frequencies that fall within a fourth bucketized range of 61%-80% and, therefore, may have a third degree of shading that corresponds to a degree of conservation of 4. Motif 246, motif 244, and motif 249 may have frequencies that fall within a fifth bucketized range of 81%-100% and, therefore, may fourth degree of shading that corresponds to a degree of conservation of 5.

Turning to FIG. 2K, an example of information that may be displayed to a downstream consumer via GUI 228 is shown. Multiple perturbated outputs (e.g., perturbated outputs 210 described in FIG. 2A) may be displayed to the downstream consumer. For example, the user may select “recommendation A,” “recommendation B,” “recommendation C,” or “recommendation D.” Each recommendation may include one of perturbated outputs 210.

The downstream consumer may select recommendation D and recommendation 278 may be displayed in a pop-up window of GUI 228. Recommendation 278 may include the following text: “The proposed system design includes Server M that will host large language model (LLM) N fine-tuned on the data stored in the ten databases. Storage system C will be used for backup with configuration D. The cost of the system is $195,000 for training and $237,000 for backup.”

Recommendation 278 may include re-ordered output 268 shown in FIG. 2G and the section of recommendation 278 that includes “storage system C will be used for backup with configuration D” may be highlighted to indicate a re-ordered portion. The re-ordered portion may have been fed into a generative AI model (e.g., a second LLM) to fix grammatical errors and/or insert words to increase readability of the re-ordered portion.

Turning to FIG. 2L, variability information for recommendation 278 is shown. For example, GUI 228 may display recommendation 278 and three motifs of recommendation 278 are shown with different degrees of shading to indicate degrees of variability.

For example, a downstream consumer may select the motif “configuration D” and variability information 280 for the motif may be displayed in a pop-up window. Variability information 280 may include a note indicating that at least the selected motif was re-ordered for clarity. In addition, variability information may indicate a degree of variability of 5, additional information related to the degree of variability (e.g., that a degree of variability may be a high degree of variability), and/or other information (e.g., a range, an average, a standard deviation). Variability information 280 may indicate stability of the selected motif and, therefore, may be usable by the downstream consumer to make decisions.

As discussed above, the components of FIG. 1 may perform various methods to manage a data processing system. FIG. 3 illustrates methods that may be performed by the components of the system of FIG. 1. In the diagram discussed below and shown in FIG. 3, any of the operations may be repeated, performed in different orders, and/or performed in parallel with or in a partially overlapping in time manner with other operations.

Turning to FIG. 3, a flow diagram illustrating a method of providing computer-implemented services using generative AI models in accordance with an embodiment is shown. The method may be performed, for example, by any of the components of the system of FIG. 1, and/or other components not shown therein.

At operation 300, a prompt may be obtained for a first generative AI model of generative AI models. Obtaining the prompt for the first generative AI model may include: (i) reading the prompt from storage, (ii) receiving (e.g., via a communication system) the prompt from another entity, (iii) receiving the prompt as part of user feedback submitted via a GUI (e.g., a chat interface displayed on the user's device), and/or (iv) other methods.

At operation 302, the prompt may be iteratively perturbated to obtain perturbated prompts. Iteratively perturbating the prompt may include: (i) during a first perturbation, removing a first information element (e.g., one or more tokens) of the prompt obtain a first perturbated prompt, (ii) during a second perturbation, removing a second information element of the prompt to obtain a second perturbated prompt, and/or (iii) other methods. Iteratively perturbating the prompt may include any number of perturbations to obtain any number of perturbated prompts.

Iteratively perturbating the prompt may also include: (i) replacing the first information element with a first replacement information element to obtain a third perturbated prompt, (ii) replacing the first information element with a second replacement information element to obtain a fourth perturbated prompt, and/or (iii) other methods.

Removing the first information element may include: (i) selecting the first information element (e.g., randomly, based on a schema, based on feedback from a downstream consumer, based on feedback from a subject matter expert), (ii) deleting the first information element from the prompt, (iii) using a model (e.g., a second generative AI model) to create the first perturbated prompt, and/or (iv) other methods.

Replacing the first information element with the replacement information element may include: (i) deleting the first information element from the prompt, (ii) adding the replacement information element to the prompt, (iii) providing the replacement information element and the prompt to another entity responsible for replacing the first information element, and/or (iv) other methods.

If the at least one action performed as part of iteratively perturbating the prompt includes replacing the first information element with a replacement information element, the replacement information element may be obtained prior to replacing the first information element.

Obtaining the replacement information element may include: (i) obtaining an information element replacement schema (e.g., from storage, from another entity via a communication system, from a downstream consumer via a GUI), (ii) reading instructions from the information element replacement schema (e.g., for selecting the first information element, for obtaining the replacement information element), (iii) selecting, based on the information element replacement schema, the first information element, (iv) performing a search process (e.g., a lookup process, a RAG process) using the first information element to obtain one or more replacement information elements (e.g., from a database, from another entity, from any number of other data sources), and/or (v) other methods.

At operation 304, the first generative AI model and the perturbated prompts may be used to obtain perturbated outputs. Using the first generative AI model and the perturbated prompts to obtain the perturbated outputs may include: (i) feeding perturbated prompts (e.g., as is, following data processing such as a RAG process) into the first generative AI model to obtain the plurality of the outputs from an output layer of the first generative AI model, (ii) providing the perturbated prompts to another entity responsible for operating the first generative AI model, and/or (iii) other methods.

At operation 306, motifs may be obtained for the perturbated outputs. The motifs may include portions of the perturbated outputs that occur repeatedly among the perturbated outputs. Obtaining the motifs may include feeding the perturbated outputs into a motif discovery algorithm configured to ingest the perturbated outputs and generate, using the perturbated outputs, the motifs. The motif discovery algorithm may be read from storage, received from another entity, and/or trained using an untrained algorithm and any number of constraints (e.g., goals for the motifs, the conservation schema, the similarity criteria).

Performing the motif discovery algorithm may also include: (i) obtaining a first sequence of tokens of the sequences of the tokens that corresponds to a first perturbated output of the perturbated outputs, (ii) obtaining, using at least the first sequence of tokens, the perturbated outputs, and the similarity criteria, first motifs for the first sequence of tokens and frequencies of occurrence for the first motifs in other perturbated outputs of the perturbated outputs, (iii) assigning, using the frequencies of occurrence and the conservation schema, first degrees of conservation of the degrees of conservation for the first motifs, and/or (iv) other methods.

Obtaining the first sequence of tokens may include: (i) reading the first sequence of tokens from storage, (ii) receiving the first sequence of tokens from another entity (e.g., via a communication system, via an application programming interface (API)), (iii) generating the first sequence of tokens using a generative AI model (e.g., extracting tokens of the first sequence of the tokens from text using natural language processing and/or other methods), and/or (iv) other methods.

Obtaining the first motifs may include: (i) searching, using similarity criteria, the perturbated outputs for repeat instances of sequences of tokens (e.g., using an algorithm such as one adapted from MEME), (ii) providing the perturbated outputs and/or the first sequence of tokens to another entity responsible for identifying the first motifs, and/or (iii) other methods.

At operation 308, an output alignment optimization process may be performed using an output alignment optimization schema to obtain aligned outputs. Performing the output alignment optimization may include: (i) identifying, using the output alignment optimization schema, a motif consensus for the motifs, the motif consensus indicating a most common ordering for the motifs, (ii) re-ordering, based on the motif consensus and the output alignment optimization schema, motifs of one or more of the perturbated outputs to obtain re-ordered outputs, (iii) shifting, using the output alignment optimization schema, portions of the re-ordered outputs to increase alignment between placement of the portions of the re-ordered outputs to generate the aligned outputs, and/or (iv) other methods.

Identifying the motif consensus for the motifs may include: (i) obtaining an ordering of motifs for each perturbated output of the perturbated outputs, (ii) counting the orderings to identify most common orderings for the motifs, (iii) using the most common ordering as the motif consensus, and/or (iv) other methods.

Re-ordering the motifs may include: (i) modifying at least one ordering of the motifs to match (e.g., to an extent considered acceptable) the motif consensus, (ii) providing the motif consensus and the perturbated outputs to another entity responsible for modifying at least a portion of the ordering of motifs (iii) feeding the motif consensus and the perturbated outputs into a model or algorithm trained to re-order motifs, and/or (iv) other methods.

Shifting the portions of the re-ordered outputs may include: (i) performing any alignment algorithm (e.g., dynamic programming, progressive alignment construction, iterative methods, consensus methods) using sequences of tokens and/or motifs for the re-ordered outputs, (ii) providing the sequences to another entity responsible for executing the algorithm, and/or (iii) other methods.

At operation 310, computer-implemented services may be provided using at least the aligned outputs. Providing the computer-implemented services may include: (i) comparing the aligned outputs to obtain variability information for the aligned outputs, (ii) populating a graphical user interface (GUI) using at least the variability information and the aligned outputs to obtain a populated GUI, and/or other methods.

Comparing the aligned outputs may include: (i) computing differences between portions of a first perturbated output of the perturbated outputs and corresponding portions of other perturbated outputs of the perturbated outputs, (ii) obtaining degrees of variability based on the difference (e.g., using a schema for assigning degrees of variability based on differences), and/or (iii) other methods.

Comparing the aligned outputs may also include obtaining frequencies of occurrence and/or degrees of conservation for motifs of a first aligned output of the aligned outputs. Obtaining the frequencies of occurrence may include: (i) identifying (e.g., manually, using a trained inference model or algorithm for similarity analysis) other tokens in the other perturbated outputs that meet the similarity criteria for being considered same motifs as the first motifs, (ii) counting the total number of instances of the first motifs to obtain the frequencies of the occurrences for the first motifs, and/or (iii) other methods. Obtaining the frequencies of the occurrences of the first motifs may also include providing the first motifs and the other perturbated outputs to another entity responsible for searching the other perturbated outputs for occurrences of the first motifs.

Obtaining the degrees of conservation for the first motifs may include: (i) comparing each frequency of occurrence for each of the first motifs to the conservation schema to identify corresponding degrees of conservation for the first motifs, (ii) providing the conservation schema and the frequencies of occurrence to another entity, and/or (iii) other methods.

Populating the GUI with at least the aligned outputs and the variability information may include: (i) uploading, via an application programming interface (API), the aligned outputs and the variability information to the GUI, (ii) providing the aligned outputs and the variability information to another entity responsible for uploading the aligned outputs and the variability information to the GUI, and/or (iii) other methods.

Providing the computer-implemented services may also include: (i) selecting an action based on motifs of a selected aligned output of the aligned outputs, (ii) updating operation of a system using the selected action, and/or (iii) other methods.

Selecting the action may include: (i) reading the action from storage (e.g., from a list of potential actions), (ii) performing a lookup process using an action lookup table and at least a portion of the motifs as a key for the action lookup table, (iii) requesting an action from another entity based on the motifs, and/or (iv) other methods.

Updating the operation of the system using the selected action may include making any type of decision based on the selected action. For example, the selected action may include a recommended action included in one or more of the motifs and updating the operation of the system may include performing the recommended action (e.g., updating a driver, re-installing a software program, re-starting a hardware component).

The method may end following operation 310.

Thus, as illustrated above, embodiments disclosed herein may provide systems and methods usable to provide computer-implemented services using generative AI models. By providing variability information to a downstream consumer along with aligned outputs generated by the generative AI model in response to a prompt, a likelihood of the outputs meeting needs of the downstream consumer may be increased.

Any of the components illustrated in FIGS. 1-2L may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g., circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for providing computer-implemented services using generative artificial intelligence (AI) models, the method comprising:
obtaining a prompt for a first generative AI model of the generative AI models;
iteratively perturbating the prompt to obtain perturbated prompts;
using the first generative AI model and the perturbated prompts to obtain perturbated outputs;
obtaining motifs for the perturbated outputs, the motifs comprising portions of the perturbated outputs that occur repeatedly among the perturbated outputs;
performing, using an output alignment optimization schema and the motifs, an output alignment optimization process to obtain aligned outputs, the aligned outputs comprising one or more re-ordered motifs of the motifs to increase alignment between different perturbated outputs of the perturbated outputs; and
providing computer-implemented services to a downstream consumer using at least the aligned outputs.

2. The method of claim 1, wherein performing the output alignment optimization process comprises:
identifying, using the output alignment optimization schema, a motif consensus for the motifs, the motif consensus indicating a most common ordering for the motifs;
re-ordering, based on the motif consensus and the output alignment optimization schema, motifs of one or more of the perturbated outputs to obtain re-ordered outputs; and
shifting, using the output alignment optimization schema, portions of the re-ordered outputs to increase alignment between placement of the portions of the re-ordered outputs to generate the aligned outputs.

3. The method of claim 2, wherein the output alignment optimization schema is used to align the portions of the perturbated outputs, the output alignment optimization schema comprising an objective function that proportionally penalizes re-ordering based on an extent of the re-ordering.

4. The method of claim 1, wherein the portions of the perturbated outputs comprise one or more tokens of sequences of tokens associated with each perturbated output of the perturbated outputs.

5. The method of claim 4, wherein a token of the one or more tokens comprises at least one type of token selected from a list of types of tokens consisting of:
a word;
a letter;
a punctuation mark; and
a phrase.

6. The method of claim 1, wherein obtaining the motifs comprises:
obtaining a first sequence of tokens corresponding to a first perturbated output of the perturbated outputs; and
obtaining, using at least the first sequence of tokens, the perturbated outputs, and similarity criteria, first motifs for the first sequence of tokens and frequencies of occurrence for the first motifs in other perturbated outputs of the perturbated outputs.

7. The method of claim 6, wherein the similarity criteria indicate an acceptable deviation in information content for a first motif of the first motifs to be considered a same motif as a second motif of the first motifs.

8. The method of claim 1, wherein providing the computer-implemented services comprises:
comparing the aligned outputs to obtain variability information for the aligned outputs, the variability information comprising at least one type of information selected from a list of types of information consisting of:
differences between portions of a first aligned output of the aligned outputs and other aligned outputs of the aligned outputs; and
frequencies of occurrence for motifs of the first aligned output in the other aligned outputs.

9. The method of claim 8, wherein providing the computer-implemented services further comprises:
populating, using at least the variability information and the aligned outputs, a graphical user interface (GUI) to obtain a populated GUI, the populated GUI being accessible by the downstream consumer.

10. The method of claim 1, wherein providing the computer-implemented services comprises:
populating, using at least the aligned outputs, a graphical user interface (GUI) to obtain a populated GUI, the populated GUI being viewable by the downstream consumer.

11. The method of claim 10, wherein the populated GUI highlights at least re-ordered motifs of a selected aligned output of the aligned outputs to focus an attention of the downstream consumer on at least the re-ordered motifs.

12. The method of claim 10, wherein providing the computer-implemented services further comprises:
selecting an action based on motifs of a selected aligned output of the aligned outputs; and
updating operation of a system using the selected action.

13. The method of claim 1, wherein iteratively perturbating the prompt comprises:
obtaining first information elements of the prompt; and
performing at least one action selected from a list of actions consisting of:
removing a first information element of the first information elements to obtain a first perturbated prompt of the perturbated prompts, and
replacing the first information element with a replacement information element to obtain the first perturbated prompt.

14. The method of claim 1, wherein the first generative AI model is a large language model (LLM).

15. A non-transitory machine-readable medium having instructions stored therein, which when executed by a processor, cause the processor to perform operations for providing computer-implemented services using generative artificial intelligence (AI) models, the operations comprising:
obtaining a prompt for a first generative AI model of the generative AI models;
iteratively perturbating the prompt to obtain perturbated prompts;
using the first generative AI model and the perturbated prompts to obtain perturbated outputs;
obtaining motifs for the perturbated outputs, the motifs comprising portions of the perturbated outputs that occur repeatedly among the perturbated outputs;
performing, using an output alignment optimization schema and the motifs, an output alignment optimization process to obtain aligned outputs, the aligned outputs comprising one or more re-ordered motifs of the motifs to increase alignment between different perturbated outputs of the perturbated outputs; and
providing computer-implemented services to a downstream consumer using at least the aligned outputs.

16. The non-transitory machine-readable medium of claim 15, wherein performing the output alignment optimization process comprises:
identifying, using the output alignment optimization schema, a motif consensus for the motifs, the motif consensus indicating a most common ordering for the motifs;
re-ordering, based on the motif consensus and the output alignment optimization schema, motifs of one or more of the perturbated outputs to obtain re-ordered outputs; and
shifting, using the output alignment optimization schema, portions of the re-ordered outputs to increase alignment between placement of the portions of the re-ordered outputs to generate the aligned outputs.

17. The non-transitory machine-readable medium of claim 16, wherein the output alignment optimization schema is used to align the portions of the perturbated outputs, the output alignment optimization schema comprising an objective function that proportionally penalizes re-ordering based on an extent of the re-ordering.

18. A data processing system, comprising:
a processor; and
a memory coupled to the processor to store instructions, which when executed by the processor, cause the processor to perform operations for providing computer-implemented services using generative artificial intelligence (AI) models, the operations comprising:
obtaining a prompt for a first generative AI model of the generative AI models;
iteratively perturbating the prompt to obtain perturbated prompts;
using the first generative AI model and the perturbated prompts to obtain perturbated outputs;
obtaining motifs for the perturbated outputs, the motifs comprising portions of the perturbated outputs that occur repeatedly among the perturbated outputs;
performing, using an output alignment optimization schema and the motifs, an output alignment optimization process to obtain aligned outputs, the aligned outputs comprising one or more re-ordered motifs of the motifs to increase alignment between different perturbated outputs of the perturbated outputs; and
providing computer-implemented services to a downstream consumer using at least the aligned outputs.

19. The data processing system of claim 18, wherein performing the output alignment optimization process comprises:
identifying, using the output alignment optimization schema, a motif consensus for the motifs, the motif consensus indicating a most common ordering for the motifs;
re-ordering, based on the motif consensus and the output alignment optimization schema, motifs of one or more of the perturbated outputs to obtain re-ordered outputs; and
shifting, using the output alignment optimization schema, portions of the re-ordered outputs to increase alignment between placement of the portions of the re-ordered outputs to generate the aligned outputs.

20. The data processing system of claim 18, wherein the output alignment optimization schema is used to align the portions of the perturbated outputs, the output alignment optimization schema comprising an objective function that proportionally penalizes re-ordering based on an extent of the re-ordering.
